(19) United States
(12) Patent Application Publication
(10) Pub. No.: US 2007/0061381 A1
(43) Pub. Date: Mar. 15, 2007

(54) Methods, systems and computer program products for managing user information across multiple devices associated with the user

(76) Inventors: Gregory Newton, Dunwoody, GA (US); Phillip Weeks, Atlanta, GA (US)

Correspondence Address: MYERS BIGEL SIBLEY & SAJOVEC, P.A., P.O. BOX 37428, RALEIGH, NC, 27627, US

(21) Appl. No.: 11/315,573

(22) Filed: Dec. 22, 2005

Related U.S. Application Data
(60) Provisional application No. 60/717,224, filed on Sep. 15, 2005.

(51) Int. Cl. G06F 17/30

(52) U.S. Cl. 707/201

(57) ABSTRACT

Methods, systems and computer program products are provided for managing user information across multiple devices associated with the user. A master version of user information that is accessible by two or more devices associated with the user is provided. The user information may be updated at one of the two or more devices associated with the user. The updated user information may be automatically sent to remaining ones of the two or more devices associated with the user responsive to updating the user information.

### CROSS REFERENCE TO RELATED APPLICATION

This Application is related to and claims the priority from U.S. Provisional Patent Application Ser. No. 60/717,224, filed Sep. 15, 2005, entitled Systems and Methods for Managing Information Across Multiple Devices, the disclosure of which is hereby incorporated herein by reference.

### FIELD OF THE INVENTION

The present invention generally relates to the field of communications services and, more particularly, to user databases for communications services.

### BACKGROUND OF THE INVENTION

It is becoming more commonplace for people to own more than one communications device that allows communication between users. For example, people communicate using home phones, work phones, mobile phones and the like. Furthermore, people also communicate using devices, such as personal computers (PCs), personal digital assistants (PDAs), pagers and the like, using, for example, email and instant messaging functionalities of these devices.

With all these communications options available, managing profiles and contact information stored in these devices may become more complicated and tedious. For example, while on a business trip a user of a PDA may obtain several new contacts and may enter the information for the new contacts into the PDA. However, once the user returns home, the contact information in each of the other devices will have to be updated so that the newly obtained contact information will be available no matter which communication device is being used. Furthermore, if the user loses the PDA before the contact information is stored in the other devices, the newly obtained, as well as the old, contact information may be lost.

### SUMMARY OF THE INVENTION

Some embodiments of the present invention provide methods, systems and computer program products for managing user information across multiple devices associated with the user. A master version of user information that is accessible by at least two devices associated with the user is provided. The user information may be updated at one of the at least two devices associated with the user. The updated user information may be automatically sent to remaining ones of the at least two devices associated with the user responsive to updating the user information.

In further embodiments of the present invention, the updated user information may be formatted for the remaining ones of the devices associated with the user. In certain embodiments of the present invention, the master version is stored on a network accessible by the at least two devices.

In still further embodiments of the present invention, the updated user information may be automatically sent to the network. The stored master version of the user information at the network may be updated. The updated user information may be automatically sent from the network to the remaining ones of the at least two devices associated with the user responsive to updating the stored master version.

In some embodiments of the present invention, the updated user information may be received at the remaining ones of the at least two devices associated with the user. The user information stored at the remaining ones of the at least two devices may be updated responsive to the received updated user information.

In further embodiments of the present invention, permission from the user may be obtained to update the user information stored at the remaining ones of the at least two devices. The user information may be updated if permission is obtained.

In still further embodiments of the present invention, the at least two devices may include a mobile phone, a personal digital assistant (PDA), a personal computer (PC) and/or a pager. The user information may include settings, preferences, address book entries, profiles and/or ringtones.

Some embodiments of the present invention provide methods, systems and computer program products for managing user information across multiple devices associated with the user. A master version of user information may be provided on a network. The network may be accessible by at least two devices associated with the user. The master version of the user information may be updated on the network. An update may be automatically sent from the network to the at least two devices associated with the user responsive to updating the master version of the user information.

In further embodiments of the present invention, the update may be received at the at least two devices associated with the user. The user information stored at the at least two devices may be updated responsive to the received update. Permission may be obtained from the user to update the user information stored at the at least two devices. The user information may be updated if permission is obtained.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE FIGURES

Other features of the present invention will be more readily understood from the following detailed description of exemplary embodiments thereof when read in conjunction with the accompanying drawings, in which:

FIG. 1 is a block diagram of a data processing system suitable for use in networks and/or devices according to some embodiments of the present invention.

FIG. 2 is a block diagram of a system including a network and devices according to some embodiments of the present invention.

FIGS. 3 through 6 are flowcharts illustrating operations for managing user information across multiple devices associated with the user according to some embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or flowchart illustrations of methods, apparatus, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

It will be understood that at least a portion of the communications described herein can be provided according to Session Initiation Protocol (SIP), which is described in more detail in, for example, “Internet Communications Using SIP,” by Henry Sinnreich, ISBN: 0-471-41399-2. Internet Protocol communications are generally described in, for example, “TCP/IP Protocol Suite,” by Behrouz A Forouzan, ISBN: 0-07-119962-4. Moreover, techniques for the creation and operation of virtual communities, is described in, for example, “Design for Community: The Art of Connecting Real People in Virtual Places,” by Derek M. Powazek, ISBN: 0-7357-1075-9. The content these references is incorporated herein by reference.

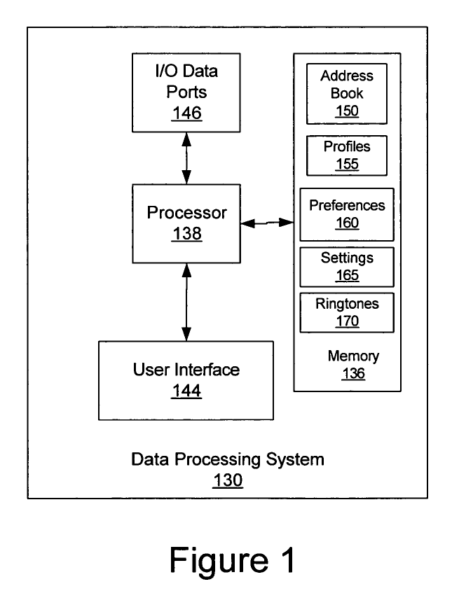

Some embodiments of the present invention will now be discussed with respect FIGS. 1 through 6. As discussed herein, some embodiments of the present invention provide master user information, for example, settings, preferences, address book entries, profiles ringtones and the like. The master user information may be stored at a network and may be accessed by multiple devices, for example, mobile phones, pagers, personal digital assistants (PDAs), personal computers (PCs) and the like. Thus, when user information is updated at a device or at the network, the updated user information may be automatically sent to other devices associated with the user and/or the network. Therefore, the master user information at the network and the user information at the devices associated with the user may all include the same information.

For example, typically if a user loses their mobile phone, their address book and/or custom settings would have to be recreated. This is not a simple process, especially when the mobile phone was the only database housing the information. According to some embodiments of the present invention, the user could access the master user information at the network and download it onto their new phone instead of recreating their address book, custom settings and the like.

As will be discussed herein, some embodiments of the present invention allow for settings, preferences, address book entries, profiles, ringtones, and the like, to be easily copied and transferred between handheld devices, personal computers (PCs), network databases and the like. Providing a master version of the user information on a database at the network, remote from the devices associated with the user, may allow large numbers of devices to have replicated settings based on a single original device, such as a mobile phone.

In some embodiments of the present invention, when a user updates his contact information, for example, changes his email address, the change may prompt a “change of email address” to be emailed out to all the contacts in the address book or a buddy list, etc. Furthermore, if a telephone number changes, callers may hear an announcement directing them to the new number.

Referring now to FIG. 1, an exemplary embodiment of a data processing system 130 that may be included in a network or a device, for example, a pager, a mobile phone, a personal computer, a PDA and the like, in accordance with some embodiments of the present invention will be discussed. The data processing system 130, may include a user interface 144, including, for example, input device(s) such as a keyboard or keypad, a display, a speaker and/or microphone, and a memory 136 that communicates with a processor 138. The data processing system 130 may further include an I/O data port(s) 146 that also communicates with the processor 138. The I/O data ports 146 can be used to transfer information between the data processing system 130 and another computer system or a network that may be associated with a communications service provider or user communication devices using, for example, an Internet Protocol (IP) connection. These components may be conventional components such as those used in many conventional data processing systems, which may be configured to operate as described herein.

As shown in the embodiments of FIG. 1, the memory 136 includes an address book 150, profiles 155, preferences 160, settings 165 and ringtones 170. The elements shown in the memory 136 are provided for exemplary purposes only and, therefore, embodiments of the present invention are not limited to the elements illustrated therein. For example, the memory 136 may include any user information that may be stored and used by devices associated with the user. The information stored in the memory 136 is referred to collectively herein as “user information.”

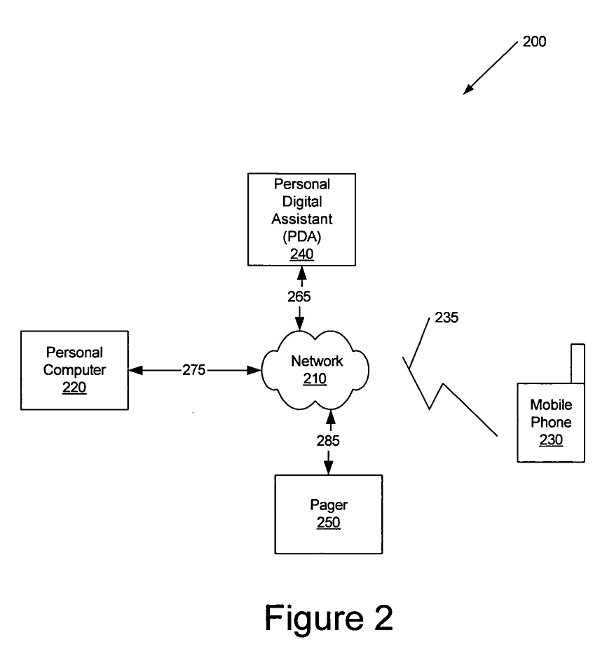

Referring now to FIG. 2, a system 200 including a network 210 and devices associated with the user will be discussed. The system 200 includes a network 210 that communicates with a personal computer 220, a PDA 240, a mobile phone 230 and a pager 250. The data processing system 130 of FIG. 1 may be included in the network 210, the personal computer 220, the PDA 240, the mobile phone 230 and/or the pager 250. The network 210 may be configured to communicate with the devices wirelessly 235 or over a physical connection 265, 275, 285 without departing from the scope of the present invention.

According to some embodiments of the present invention, a master version of user information is stored in a memory at the network 210. User information is also stored in a memory at each of the devices, for example, PC 220, PDA 240, mobile phone 230 and/or pager 250. The master version of the user information is accessible by devices associated with the user, for example, the PC 220, the PDA 240, the pager 250 and the mobile phone 230. In some embodiments of the present invention, when the user information is updated at one device associated with the user, for example, the PC 220, updated user information may be automatically sent to the remaining devices, for example, the PDA 240, the mobile phone 230 and/or the pager 250.

In some embodiments of the present invention, the updated user information may be formatted for the particular device that it is being sent to. For example, if the updated user information is being sent to the pager 250, the updated user information may be formatted for the pager 250.

In some embodiments of the present invention, the updated user information may be sent to the network 210. The master version of the user information may be updated at the network 210 and the network 210 may be configured to send the updated user information from the network to the devices, for example, a PC 220, a PDA 240, a mobile phone 230 and/or a pager 250, associated with the user responsive to updating the stored master version.

The updated user information may be received at one or more of the devices and the user information stored at the devices may be updated responsive to the received updated user information. In some embodiments of the present invention, permission may be obtained form the user prior to updating the user information stored at the device. If permission is obtained, the user information may be updated.

In some embodiments of the present invention, the master version of the user information may be updated directly and an update may be automatically sent from the network 210 to the devices associated with the user responsive to updating the master version of the user information.

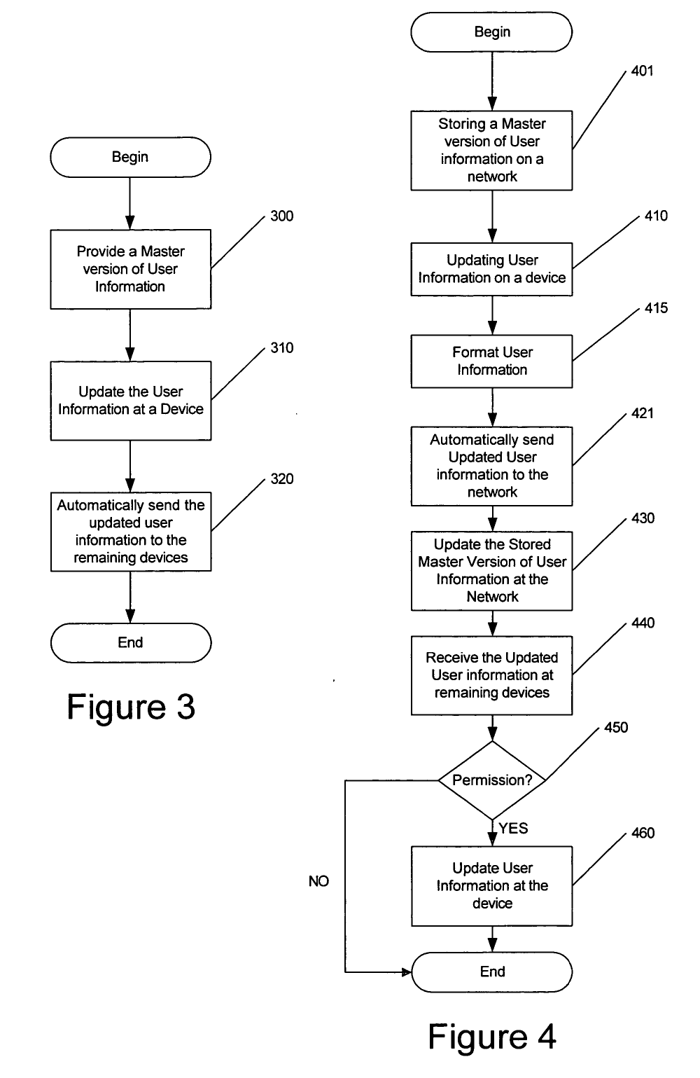

Operations according to various embodiments of the present invention will now be discussed with respect to FIGS. 3 through 6. Referring to the flowchart of FIG. 3, operations for managing user information across multiple devices associated with the user begin at block 300 by providing a master version of user information that is accessible by two or more devices associated with the user. A master version of user information, for example, settings, preferences, address book entries, profiles, ringtones and the like, may be stored at a data processing system at a network. Thus, this user information may be accessible by multiple devices, for example, a mobile phone, a personal digital assistant (PDA), a personal computer (PC) and/or a pager, associated with the user. Accordingly, if a user loses one or more of the devices, the user information can be downloaded from the network to the new device.

The user information may be updated at one of the two or more devices associated with the user (block 310). For example, the user may enter a new phone number for one of the contacts in the phonebook. The updated user information may be automatically sent to remaining ones of the two or more devices associated with the user responsive to updating the user information (block 320). For example, a message including the new phone number for the contact may be sent to one or more of the user's other devices.

Operations according to further embodiments of the present invention will now be discussed with respect to the flowchart of FIG. 4. Operations begin at block 401 by storing a master version of user information in a data processing system of a network. The master version is accessible to two or more devices associated with a user. The user information may be updated at one of the two or more devices associated with the user (block 410). The updated user information may be formatted for the remaining ones of the two or more devices associated with the user (block 415). For example, if the user information is updated at a mobile phone associated with the user and the user also has a pager and a PDA that have access to the network, the user information may be processed to be in a form recognizable to the pager and/or the PDA. The formatted updated user information may be automatically sent to the network (block 421). It will be understood that the user information may be formatted at the device at which the information is updated or at the network without departing from the scope of the present invention.

The stored master version of the user information may be updated at the network (block 430). The formatted/updated user information may be sent from the network and received at the remaining ones of the two or more devices associated with the user responsive to updating/formatting the user information (block 440). In certain embodiments of the present invention, the user may be prompted for permission to update the user information on a device before the user information is actually updated (block 450). If permission is obtained from the user (block 450), the user information may be updated at the device (block 460). If permission is not obtained (block 460), the user information may not be updated and the device may have different user information than the master version.

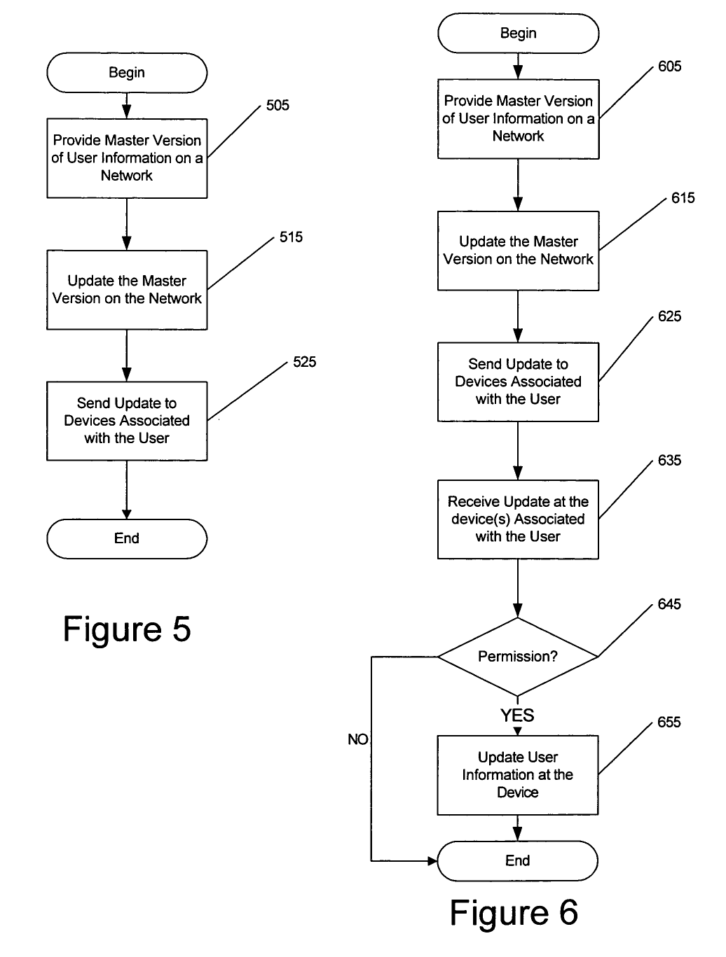

Operations according to still further embodiments of the present invention will now be discussed with respect to the flowchart of FIG. 5. Operations begin at block 505 by providing a master version of user information on a network that is accessible by two or more devices associated with the user. The master version of the user information may be updated on the network (block 515). For example, a user may log into an account on the network and update contact information associated with a contact in the phonebook. The network may be configured to automatically send an update including the updated user information from the network to the two or more devices associated with the user responsive to updating the master version of the user information (block 525).

It will be understood that in some embodiments of the present invention, the user may update his/her own information. For example, the user may change his/her email address. In these embodiments of the present invention, the data processing system at the network may be configured to send, for example, an email message, to the contacts listed in the phonebook informing them of the email change.

Operations according to some embodiments of the present invention will now be discussed with respect to the flowchart of FIG. 6. Operations begin at block 605 by providing a master version of user information on a network that is accessible by two or more devices associated with the user. The master version of the user information may be updated on the network (block 615). The network may be configured to automatically send an update including the updated user information from the network to the two or more devices associated with the user responsive to updating the master version of the user information (block 625). The update may be received at the two or more devices associated with the user (block 635). In certain embodiments of the present invention, the user may be prompted for permission to update the user information on a device before the user information is actually updated (block 645). If permission is obtained from the user (block 645), the user information may be updated at the device (block 655). If permission is not obtained (block 645), the user information may not be updated and the device may have different user information than the master version.

In the drawings and specification, there have been disclosed embodiments of the invention and, although specific terms are employed, they are used in a generic and descriptive sense only and not for purposes of limitation, the scope of the invention being set forth in the following claims.

That which claimed is:

1. A computer implemented method of managing user information across multiple devices associated with the user, comprising:
providing a master version of user information that is accessible by at least two devices associated with the user;
updating the user information at one of the at least two devices associated with the user; and
automatically sending the updated user information to remaining ones of the at least two devices associated with the user responsive to updating the user information.

2. The method of claim 1, wherein automatically sending the updated user information is preceded by formatting the updated user information for the remaining ones of the devices associated with the user.

3. The method of claim 1, wherein providing a master version is preceded by storing the master version on a network accessible by the at least two devices.

4. The method of claim 3, wherein automatically sending an update is preceded by:
automatically sending the updated user information to the network; and
updating the stored master version of the user information at the network, wherein automatically sending comprises automatically sending the updated user information from the network to the remaining ones of the at least two devices associated with the user responsive to updating the stored master version.

5. The method of claim 1, further comprising:
receiving the updated user information at the remaining ones of the at least two devices associated with the user; and
updating the user information stored at the remaining ones of the at least two devices responsive to the received updated user information.

6. The method of claim 5, wherein updating the user information is preceded by obtaining permission from the user to update the user information stored at the remaining ones of the at least two devices and wherein updating further comprises updating the user information if permission is obtained.

7. The method of claim 1, wherein the at least two devices comprise a mobile phone, a personal digital assistant (PDA), a personal computer (PC) and/or a pager.

8. The method of claim 1, wherein the user information comprises settings, preferences, address book entries, profiles and/or ringtones.

9. A computer program product for managing user information across multiple devices associated with the user, the computer program product comprising computer program code embodied in a computer readable medium, the computer program code comprising program code configured to carry out the method of claim 1.

10. A computer implemented method for managing user information across multiple devices associated with the user, the method comprising:
providing a master version of user information on a network, the network being accessible by at least two devices associated with the user;
updating the master version of the user information on the network; and
automatically sending an update from the network to the at least two devices associated with the user responsive to updating the master version of the user information.

11. The method of claim 10, further comprising:
receiving the update at the at least two devices associated with the user; and
updating user information stored at the at least two devices responsive to the received update.

12. The method of claim 11, wherein updating the user information is preceded by obtaining permission from the user to update the user information stored at the at least two devices and wherein updating the user information comprises updating the user information stored on the at least two devices if permission is obtained.

13. A computer program product for managing user information across multiple devices associated with the user, the computer program product comprising computer program code embodied in a computer readable medium, the computer program code comprising program code configured to carry out the method of claim 10.

14. A computer system configured to carry out the method of claim 10.

15. A system for managing user information across multiple devices associated with the user, comprising:
a data processing system configured to provide a master version of a user information;
at least two devices associated with the user, the at least two devices being configured to access the data processing system and one of the at least two devices being configured to update the user information stored thereon; and
an update module configured to automatically send the updated user information to remaining ones of the at least two devices associated with the user responsive to the update of the user information at one of the at least two devices.

16. The system of claim 15, wherein the update module is further configured to format the update for the remaining ones of the devices associated with the user.

17. The system of claim 15, wherein the update module is positioned at a network remote from the at least two devices and wherein the update module is further configured to update the stored master version of the user information at the network and send an update from the network to the remaining ones of the at least two devices associated with the user.

18. The system of claim 17, wherein the remaining ones of the at least two devices are further configured to receive the update and update user information stored at the remaining ones of the at least two devices responsive to the received update.

19. The system of claim 18, wherein the remaining ones of the at least two devices are further configured to obtain permission from the user to update the user information stored at the remaining ones of the at least two devices and update the user information if permission is obtained.

20. The system of claim 15, wherein the at least two devices comprise a mobile phone, a personal digital assistant (PDA), a personal computer (PC) and/or a pager.
